(19) United States
(12) Patent Application Publication
(10) Pub. No.: US 2014/0256174 A1
(43) Pub. Date: Sep. 11, 2014

(54) TERMINAL BOX FOR SOLAR CELL

(71) Applicant: ZHEJIANG JIAMING TIANHEYUAN PHOTOVOLTAIC TECHNOLOGY, LTD, Zhejiang province (CN)

(72) Inventor: WEI HUI WANG, Ci Xi City (CN)

(21) Appl. No.: 13/941,564

(22) Filed: Jul. 15, 2013

(30) Foreign Application Priority Data
Mar. 11, 2013 (CN) 201320107821.6

(51) Int. Cl. H01R 13/00

(52) U.S. Cl. CPC H01R 13/00
USPC 439/485

(57) ABSTRACT

A terminal box for solar cell includes a box body, a bottom cover, a conducting component provided in the box body, and thermal conductive gel which is provided on the box body and the bottom cover and to embrace around the conducting component for heat dissipation. The conducting component includes four conducting elements constructed independently. The thermal conductive gel, embodied as thermal conductive silica gel, which is made from primarily organic silica gel mixed with additive fillers and thermal conductive polymer materials, providing better heat dissipating ability and electrical insulation property, reducing the heat accumulation in the conducting component, enhancing an effective sealing ability for the terminal box, and preventing the occurrence of higher operation temperature of the terminal box after it has been operated for a long period of time.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to the field of a photovoltaic module arrangement, and more particularly to a terminal box for solar cell.

2. Description of Related Arts

A conventional terminal box for solar cell is installed on a photovoltaic cell panel for electrical connections. The conventional terminal box provides connection elements therein, wherein the connection elements are used to connect the electrical conductive component with electrical cables in order to deliver the electricity produced from the solar cell to an electricity network via the electrical cables.

The conventional terminal box for solar cell has poor heat dissipation ability after operated for a long period of time that fails to meet the needs of high-power solar cell module. In addition, due to the higher operation temperature of the conventional terminal box for solar cell, the sealing property of the conventional terminal box is difficult to pass the IP 67 test after it is operated for a long period of time.

As described above, the higher operation temperature problem of the conventional terminal box after it is operated for a long time becomes an unsolved problem to person who skilled in this art.

### SUMMARY OF THE PRESENT INVENTION

A main object of the present invention is to solve the above described problems by providing a terminal box for solar cell which has an innovative structure that can achieve the object of solving the high operation temperature drawback of the terminal box of solar cell after it has been operated for long period of time.

Another object of the present invention is to provide a terminal box for solar cell comprising a thermal conductive gel and conducting for enhancing heat dissipating ability so as to decease the operation temperature of the terminal box.

Accordingly, in order to accomplish the above objects, the present invention provides a terminal box for solar cell which comprises a box body, a bottom cover, a conducting component provided in the box body, and thermal conductive gel which is provided on the box body and the bottom cover and to embrace around the conducting component for heat dissipation, wherein the conducting component comprises four conducting elements constructed independently.

Preferably, the conducting component is in plate structure.

Preferably, the bottom cover is used to seal the box body and the thermal conductive gel.

The present invention provides a terminal box for solar cell, comprising a box body and conducting component provided in the box body. In order to overcome the drawback because of the heat generated after the conventional terminal box has been operated for a long period of time, the conventional terminal box for solar cell has been improved in the present invention to provide thermal conductive gel embracing the conducting component on the box body and a bottom cover so as to dissipate heat generated from the conducting component. The conducting component comprises four conducting elements provided in an independent manner The thermal conductive gel, embodied as thermal conductive silica gel, which is made from primarily organic silica gel mixed with additive fillers and thermal conductive polymer materials, providing better heat dissipating ability and electrical insulation property. In addition, the thermal conductive gel provided on the box body, bottom cover, and around the conducting component not only can promptly conduct the heat generating from the conducting component to the box body and the bottom cover as well as reduce the heat accumulation in the conducting component, but also can enhance an effective sealing ability for the terminal box, and thus preventing the occurrence of higher operation temperature of the terminal box after it has been operated for a long period of time. Furthermore, the independent structure of the four conducting elements of the conducting component enables an independent operation of the four conducting elements during the electrical conducting operation, so that the heat generated from the four conducting elements doesn't interfere with each other and thus is able to be promptly dissipated out through the thermal conductive gel that further prevents heat accumulation and enhances the heat dissipation effect thereof.

### BRIEF DESCRIPTION OF THE DRAWINGS

FIG. 1 is a schematic view of a box body according to a preferred embodiment of the present invention.

FIG. 2 is a schematic view of the bottom cover according to the preferred embodiment of the present invention.

FIG. 3 is a schematic view of the conducting component according to the preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

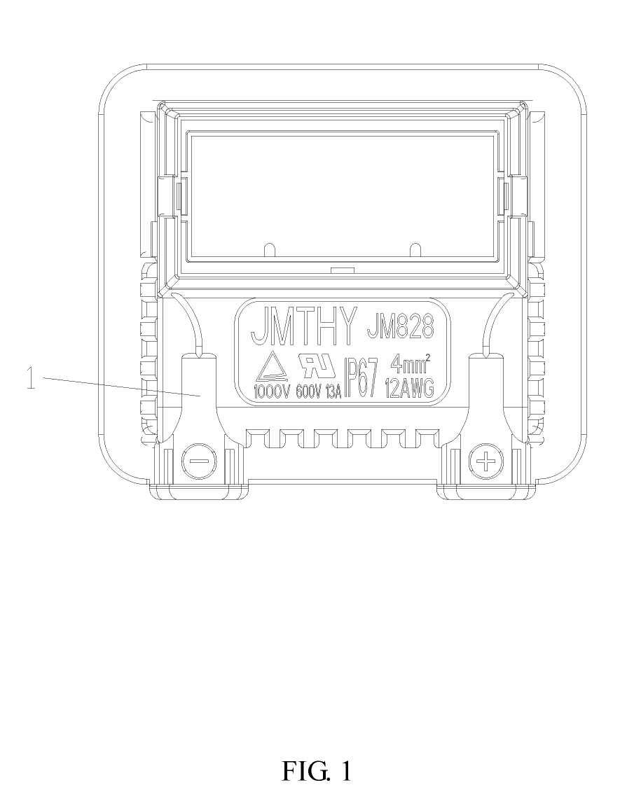

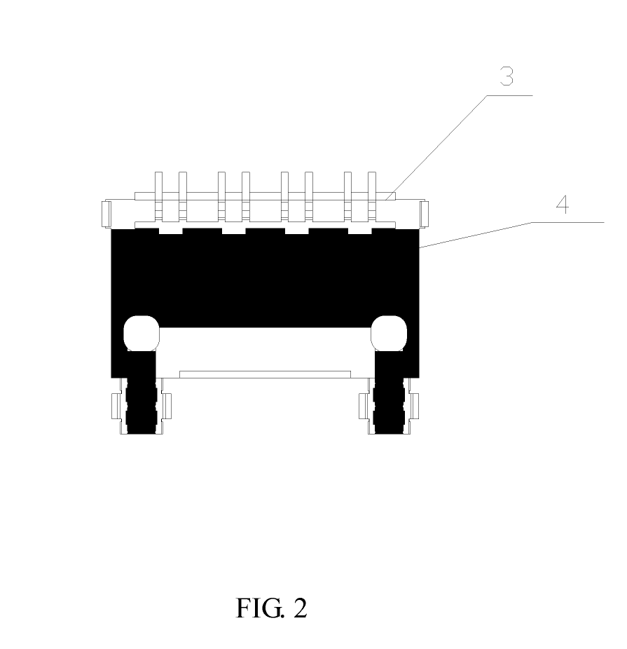

As shown in FIG. 1 and FIG. 2 of the drawings, the present invention provides a terminal box for solar cell, which comprises a box body 1, a conducting component 2 provided in the box body 1, and a thermal conductive gel 4. A bottom cover 3 is provided on the box body 1 for providing a sealing effect for the conducting component 2 and the thermal conductive gel 4. In order to overcome the heat generating drawback of the conventional terminal box after operated for a long period of time, the present invention improves the conventional terminal box by providing the thermal conductive gel 4 which is provided on the box body 1 and the bottom cover 3, and to embrace around the conducting component 2 so as to dissipate heat generated from the conducting component 2.

The thermal conductive gel 4, embodied as thermal conductive silica gel, which is made from primarily organic silica gel mixed with additive fillers and thermal conductive polymer materials, providing better heat dissipating ability and electrical insulation property. The thermal conductive gel 4 provided on the box body 1, bottom cover 3, and around the conducting component 2 not only can promptly conduct the heat generating from the conducting component 2 to the box body 1 and the bottom cover 3 as well as reduce the heat accumulation in the conducting component 2, but also can enhance an effective sealing ability for the terminal box, and thus preventing the occurrence of higher operation temperature of the terminal box after it has been operated for a long period of time.

The conducting component 2 comprises a plurality of conducting element, embodied as four conducting elements 2 having an independent structure so as to enable an independent operation of the four conducting elements 2 during the electrical conducting operation, so that the heat generated from the four conducting elements 2 doesn't interfere with each other and thus is able to be promptly dissipated out through the thermal conductive gel 4 that further prevents heat accumulation and enhances the heat dissipation effect thereof

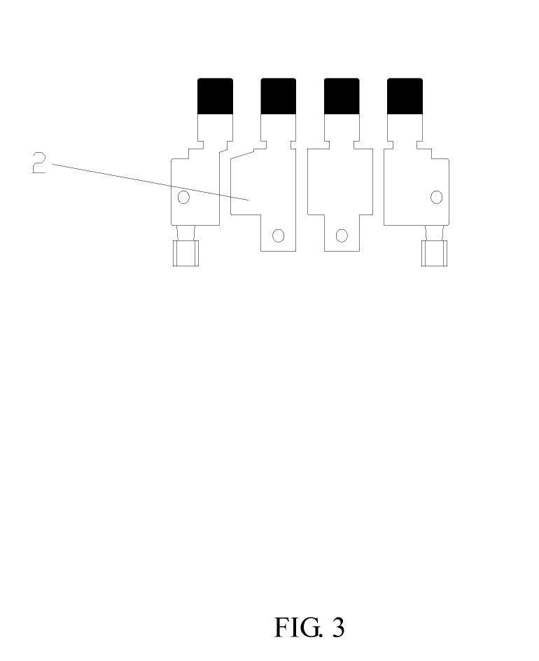

As shown in FIG. 3 of the drawings, in order to further reduce heat accumulation in the conducting component 2, the conducting component 2 is embodied as a plate structure. It is well known that when a heat generating component (such as the conducting component of the present invention) has a larger surface area, it can provide a bigger heat dissipating area for reducing heat accumulation. Accordingly, the conducting component 2 of the present invention utilities a plate structure to further enhance the heat dissipation effect.

Preferably, in order to achieve a better heat dissipation effect, the terminal box for solar cell of the present invention further comprises a ventilation and exhaust device provided on one side of the box body 1, for example a heat dissipating fan for enhancing the air flow circulation within the box body 1 so as to achieve a temperature reduction objective to prevent the temperature of the terminal box from being too high.

In addition to the embodiment as described above, the terminal box for solar cell further comprises a diode and an external cable connected with the conductive component, wherein the diode is welded with the conductive component, and then the conducting component with the diode are placed in the box body 1. Then, the thermally conductive gel is coated inside the box body 1. Finally, when a user starts to utilize the terminal box for solar cell, the user needs to weld the conducting component to connect with the bus bar of the solar cell and covers the bottom cover 3 whereon.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A terminal box for solar cell, comprising:
a box body;
a conducting component which is provided in said box body and comprises a plurality of electrically conductive elements arranged independently; and
a thermal conductive gel provided on said box body and said bottom cover, and embraced around said conducting component.

2. The terminal box for solar cell, as recited in claim 1, wherein said conducting component is in plate structure.

3. The terminal box for solar cell, as recited in claim 1, wherein said bottom cover is used to provide a sealing effect for said conducting component and said thermal conductive gel.
